(19) United States
(12) Patent Application Publication
(10) Pub. No.: US 2013/0111416 A1
(43) Pub. Date: May 2, 2013

(54) DESIGN DATA OPTIMIZATION METHOD, STORAGE MEDIUM INCLUDING PROGRAM FOR DESIGN DATA OPTIMIZATION METHOD AND PHOTOMASK MANUFACTURING METHOD

(71) Applicants: Shinichi NAKAGAWA, Yokohama-shi (JP); Chikaaki Kodama, Tokyo (JP); Kouichi Nakayama, Hiratsuka-shi (JP); Toshiya Kotani, Machida-shi (JP); Fumiharu Nakajima, Yokohama-shi (JP)

(72) Inventors: Shinichi NAKAGAWA, Yokohama-shi (JP); Chikaaki Kodama, Tokyo (JP); Kouichi Nakayama, Hiratsuka-shi (JP); Toshiya Kotani, Machida-shi (JP); Fumiharu Nakajima, Yokohama-shi (JP)

(21) Appl. No.: 13/427,025

(22) Filed: Mar. 22, 2012

(30) Foreign Application Priority Data
Nov. 2, 2011 (JP) 2011-241475

(51) Int. Cl. G06F 17/50

(52) U.S. Cl. 716/51; 716/54

(57) ABSTRACT

According to one embodiment, a design data optimization method includes forming an angular aperture model, in first design data including a first and a second line patterns indicating an interconnect layout, based on an angular aperture between the first line pattern in which a conversion difference prediction point is set in a vertical direction and the second line pattern, and changing a distance between the first and second line patterns or a line width of the first and second line patterns in the first design data based on the angular aperture model and optimizing the first design data to second design data including the first and second line patterns changed.

### CROSS-REFERENCE TO RELATED APPLICATIONS

This application is based upon and claims the benefit of priority from prior Japanese Patent Application No. 2011-241475, filed Nov. 2, 2011, the entire contents of which are incorporated herein by reference.

### FIELD

Embodiments described herein relate generally to a design data optimization method, a storage medium including a program for a design data optimization method and a photomask manufacturing method.

### BACKGROUND

In designing a semiconductor device, a circuit is first designed according to the specification of a product and then a circuit pattern to be formed on a silicon wafer is drawn. At this time, design data indicating an interconnect pattern on the wafer is formed based on a drawing rule that is called a design rule defined based on various restrictions (such as minimum dimensions, interconnect distances, shapes and the like) in the semiconductor process.

In order to reduce the TAT (Turn Around Time), the design data may be formed in some cases before the process condition is determined.

As described above, the design rule used for forming design data is a rule on which a process condition of a semiconductor device to be formed is reflected. Then, a changed process condition is not reflected on the formed design data if the process condition is changed after the design data is formed. Therefore, the changed process condition is reflected on design data and optimizes the interconnect pattern in the design data.

As a result, it is preferably to simply and adequately to optimize an interconnect pattern in design data to cope with a change in the process condition when taking the efficiency of manufacturing of semiconductor devices into consideration.

### BRIEF DESCRIPTION OF THE DRAWINGS

FIG. 1 is a schematic diagram showing the configurations for performing a design data optimization method of this embodiment.

FIG. 2A is a view for illustrating an angular aperture model.

FIG. 2B is a view for illustrating an angular aperture model.

FIG. 2C is a diagram for illustrating an angular aperture model.

FIG. 3 is a flowchart for illustrating the design data optimization method of this embodiment.

FIG. 4 is a diagram for illustrating the design data optimization method of this embodiment.

FIG. 5A is a diagram for illustrating the design data optimization method of this embodiment.

FIG. 5B is a diagram for illustrating the design data optimization method of this embodiment.

FIG. 6A is a view for illustrating the design data optimization method of this embodiment.

FIG. 6B is a view for illustrating the design data optimization method of this embodiment.

FIG. 6C is a view for illustrating the design data optimization method of this embodiment.

### DETAILED DESCRIPTION

### Embodiment

The present embodiment is explained in detail below with reference to the drawings. In the following explanation, the same symbols are attached to elements that have the same functions and configurations and overlapped portions are explained when required.

In general, according to one embodiment, a design data optimization method includes forming an angular aperture model, in first design data including a first and a second line patterns indicating an interconnect layout of a semiconductor device, based on an angular aperture between the first line pattern in which a conversion difference prediction point is set in a vertical direction with respect to a wafer surface and the second line pattern adjacent the first line pattern; and changing at least one of a distance between the first and second line patterns and a line width of the first and second line patterns included in the first design data based on the angular aperture model and optimizing the first design data to second design data including the first and second line patterns changed.

### (1) Embodiment

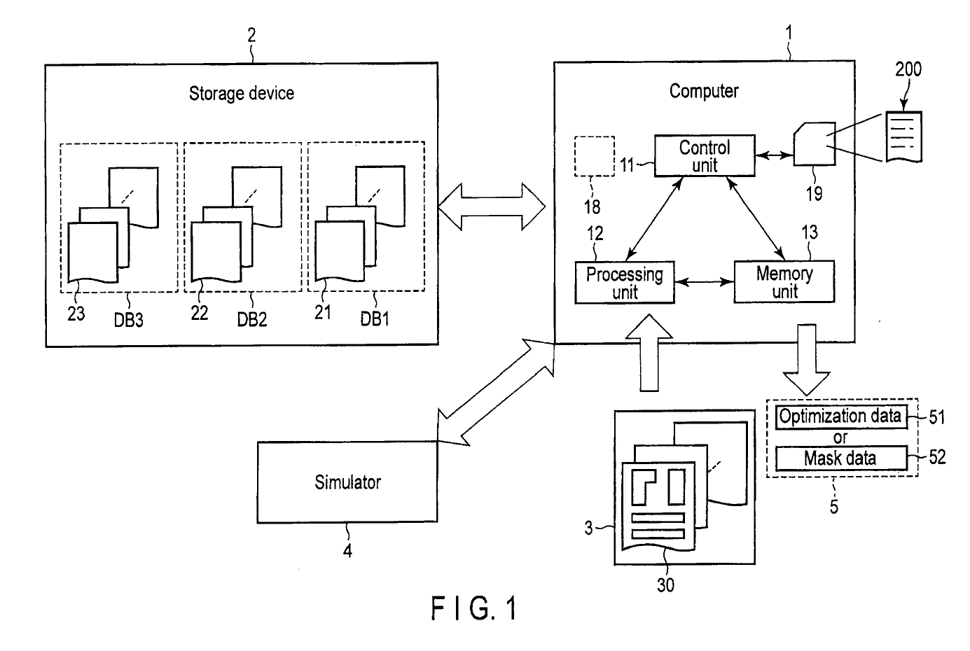

A design data optimization method and photomask manufacturing method (mask data formation method) according to an embodiment are explained with reference to FIG. 1 to FIG. 6C.

(a) Configuration

FIG. 1 is a diagram showing the configurations for performing a design data optimization method and photomask manufacturing method (mask data formation method) of this embodiment.

As shown in FIG. 1, the design data optimization method and mask data formation method of this embodiment are performed by using a computer 1 and databases DB1, DB2, DB3 stored in a storage device 2.

The computer 1 includes a control unit 11, processing unit 12 and memory unit 13.

To the computer 1, design data 3 for forming semiconductor devices is input. The design data 3 includes a plurality of data items (also called layer data) 30 such as pattern data indicating gate patterns of field effect transistors formed on a wafer and a layout of a well (impurity region) formed in the wafer, pattern data indicating the shapes and layout of interconnections (line patterns, interconnect patterns) used for connecting elements on respective interconnect levels and the like to cope with respective manufacturing steps for forming the semiconductor device. Thus, the design data indicating the interconnect layout of the semiconductor device includes a plurality of line patterns. The respective line patterns in the design data correspond to the interconnections of the semiconductor device and have preset interconnect widths (line width) according to the interconnect layout of the semiconductor device. The respective line patterns in the design data are arranged adjacent to one another with preset spaces (interconnect distances, intervals).

The design data 3 may be manually formed or may be automatically formed based on an interconnect diagram of a circuit by using a processing device. Further, the design data 3 may be data formed before the process condition is determined or may be data formed after the process condition was determined.

For example, the control unit 11 includes software (program) 200 used for performing the design data optimization method and mask data formation method of this embodiment with respect to input design data 3. The control unit 11 causes the processing unit 12 to perform a optimization process for the design data 3 and a mask data forming process based on the optimized design data in the present embodiment that will be described later.

The processing unit 12 performs a calculation process for the optimization process for the design data 3 and the mask data forming process under control of the control unit 11.

The memory unit 13 temporarily stores the calculation result of the processing unit 12. For example, the memory unit 13 temporarily stores data from the exterior of the computer 1 such as data of the storage device 2 or design data 3.

For example, the computer 11 includes a tool 18 that optimizes design data or a tool 18 used by the control unit 11 and processing unit 12 to detect a portion (for example, that is called an error point, error, process an error portion or hot spot) in which a short circuit or open circuit (short/open) occurs at the time of formation of a semiconductor device in design data or mask data formed based on design data. The tool 18 having a function of designing an interconnect pattern/interconnect layout of the semiconductor device is called a design tool 18. The design tool 18 is provided as software, for example. The design tool 18 includes a tool for a design data optimization process that is called Target MDP, for example.

The storage device 2 stores a plurality of databases DB1, DB2, DB3.

In database (that is hereinafter also referred to as a fitting pattern database) DB1, a plurality of fitting pattern data items 21 used for forming angular aperture models that will be described later are stored. In database (that is hereinafter also referred to as an angular aperture model database) DB2, a plurality of data items 22 indicating angular aperture models are stored. In database (that is hereinafter also referred to as an error point detection rule database) DB3, a plurality of data items 23 indicating error point detection rules are stored.

For example, the error point detection rule is a rule for detecting an interconnect pattern and interconnect layout including an error point at which an interconnect failure (short circuit or open circuit) may occur from design data or mask data based on the minimum dimensions of the interconnect pattern, the minimum spaces between the interconnections, the shape of the interconnection and the like in one process condition.

The storage device 2 is an HDD or server, for example.

A simulator 4 does a simulation by lithography with respect to mask data (or design data), for example. Further, the simulator 4 may be incorporated in the computer 1.

The program 200 for performing the design data optimization method and photomask manufacturing method (mask data formation method) of this embodiment may be supplied from a storage medium 19 such as a memory card or optical disk to the control unit 11 of the computer 1. Further, the program 200 may be supplied to the control unit 11 via a communication line such as an Internet or radio communication line. Data items 21, 22, 23 of databases DB1, DB2, DB3 may be supplied to the computer 1 via the communication line. Further, the design tool 18 may be a program stored in the memory unit 13 of the computer 1, a program stored in the storage medium 19 or a program provided from the exterior of the computer 1.

The computer 1 performs an optimization process for input design data 3 by use of databases DB1, DB2 in the storage device 2 based on the design data optimization method of this embodiment that will be described later. Then, the computer 1 outputs optimization data 51 of the design data 3 as output data 5 to the exterior of the computer. Further, the computer 1 performs an optimization process for input design data 3 and mask data formation process by use of databases DB1, DB2, DB3 in the storage device 2 based on the design data optimization method and mask data formation method of this embodiment that will be described later. Then, the computer 1 can output mask data 52 as output data 5.

In the design data optimization method and mask data formation method of the present embodiment, optimization data 51 of design data is formed by performing a data formation process and optimization process based on an angular aperture model of a line pattern (interconnect pattern) of a semiconductor device.

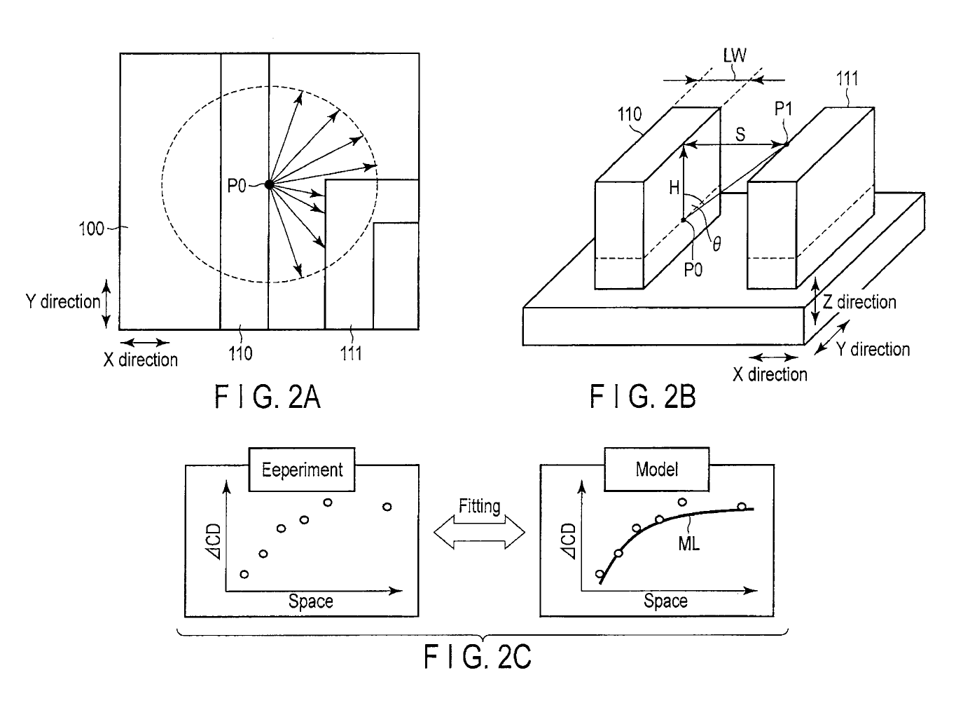

An angular aperture model used in the design data optimization method of the present embodiment is explained with reference to FIG. 2A and FIG. 2B.

FIG. 2A is a plan view schematically showing an interconnect pattern. FIG. 2B is a bird's-eye view schematically showing the interconnect pattern.

In FIG. 2A and FIG. 2B, an X direction and Y direction indicate a horizontal direction with respect to the wafer surface and a Z direction indicates a vertical direction with respect to the wafer surface. The X direction and Y direction are perpendicular to each other.

In the semiconductor device, it is preferable to form an interconnection with a shape and dimension that are not so different from those of the design pattern on the wafer in order to realize a desired electrical characteristic. Therefore, conversion difference ΔCD (that is hereinafter referred to as dimensional conversion difference ΔCD or process conversion difference ΔCD) between the dimension of the design pattern and the dimension of an interconnection formed on the wafer is previously predicted and the dimensional conversion difference is reflected on the pattern shape of the design data. A mask pattern (mask data) used in the lithography process is formed based on design data on which the dimensional conversion difference is reflected and an interconnection within the permissible range of the desired electrical characteristic is realized on the wafer.

As shown in FIG. 2A and FIG. 2B, reference point (that is hereinafter referred to as a conversion difference prediction point) P0 used for predicting dimensional conversion difference ΔCD is set at position (dimension, depth) “H” in a vertical direction (depth direction) with respect to the wafer (semiconductor substrate) surface from the upper surface of a certain interconnect pattern 110 in an angular aperture model. In this case, it is supposed that the side surface (cross section) of the interconnect pattern is vertical in the angular aperture model.

Angular aperture θ in conversion difference prediction point P0 is used for calculation of dimensional conversion difference ΔCD.

In the angular aperture model, angular aperture θ between adjacent patterns in the vertical direction with respect to the wafer surface is angle θ formed between prediction point P0 and portion P1 in which a straight line led out from conversion difference prediction point P0 does not interfere with a neighboring pattern 111 in sphere (circle) CC with conversion difference prediction point P0 set as a center. Angular aperture θ is expressed as a solid angle.

Angular aperture θ in the vertical direction with respect to the wafer surface varies depending on the position (depth, dimension “H”) of conversion difference prediction point P0 in a vertical direction with respect to the wafer surface and space dimension (that is hereinafter referred to as space length) “S” between the pattern 110 on which a conversion prediction point is set and a pattern 111 adjacent to the pattern 110 in a horizontal direction with respect to the wafer surface. For example, angular aperture θ becomes larger as space length S becomes larger and angular aperture θ becomes smaller as dimension H becomes larger.

Therefore, angular aperture θ is derived with dimension H used as a parameter by analyzing the relationship between space length S and angle θ in the vertical direction with respect to the wafer surface for each position (dimension H) of conversion difference prediction point P0 in the vertical direction with respect to the wafer surface. For example, angular aperture θ(H) with dimension H used as a parameter is indicated by “arctan(S/H)”. Angular aperture θ(H) with dimension H used as a parameter can be derived based on design data by analyzing the space length between adjacent line patterns.

Space length S between the line patterns (interconnect patterns, mask patterns) 110, 111, dimension H in the vertical direction with respect to the wafer surface, angular aperture θ and interconnect width LW of the line pattern are stored in database DB1 as fitting pattern data 21 used for forming an angular aperture model.

The magnitude of angular aperture θ gives an influence to an incident amount of an incident matter (for example, light, radical and ion) at the conversion difference prediction point and functions as a factor that varies dimensional conversion difference ΔCD. An amount of an incident matter incident on conversion difference prediction point P0 increases according to the magnitude of angular aperture θ when angular aperture θ becomes larger. Therefore, an etching amount of a member (conductor, insulator or semiconductor) processed by a mask based on the angular aperture model increases and the length or width of the interconnection may become smaller or larger.

FIG. 2C shows the relationship between the space between the interconnections and the dimensional conversion difference. As shown in FIG. 2C, dimensional conversion difference ΔCD has a correlation with angular aperture θ having the space length as a parameter. In FIG. 2C, circular marks indicate actual measurements (experimental values or simulation values). In FIG. 2C, the relationship between space length S in a position of conversion difference prediction point P0 and dimensional conversion difference ΔCD is shown. A model with the dimensional conversion difference in a certain angular aperture θ(H) is formed based on the actual measurements. For example, dimensional conversion difference ΔCD of the angular aperture model is modeled by use of an equation expressed by “ΔCD=A+B×θ(H)” (A and B in the equation are coefficients). Thus, model equation ML of the angular aperture model in a certain process condition is obtained.

Model equation ML of dimensional conversion difference ΔCD based on the angular aperture model is stored in database DB2 as data 22 of the angular aperture model.

Thus, the relationship between space length S and dimensional conversion difference ΔCD is measured, formed into a database form and stored in database DB1 in the storage device 2 for each position (dimension H) at the conversion difference prediction point in the vertical direction with respect to the wafer surface. For example, coefficients A, B in the model equation of dimensional conversion difference ΔCD can be relatively easily calculated by forming the actual measurements of the angular aperture model into a database form. For example, coefficients A, B can be calculated by use of the least squares method or the like.

For example, since angular aperture θ includes space length S as a parameter, an influence (mutual interference between adjacent patterns) of an adjacent line pattern with respect to a to-be-corrected line pattern (interconnection) is reflected on a design data optimization process using the angular aperture model.

In the design data optimization method of this embodiment, database DB1 used for calculating an angular aperture model is configured. Further, database DB2 of an angular aperture model including dimensional conversion difference ΔCD can also be configured by use of the angular aperture model.

When the process condition is changed, the design data optimization method of this embodiment can optimize the design data by performing a process (for example, Target MDP) using an angular aperture model optimized (changed) according to fitting pattern data after the process condition is determined.

The design data optimization method of this embodiment can optimize the shapes of a plurality of line patterns (interconnect patterns) included in design data based on the angular aperture model when a portion (error point) in which a short circuit or open circuit may occur at the time of formation of interconnects is detected from the design data.

The angular aperture model used in the design data optimization method of this embodiment considers angular aperture θ between one line pattern and a line pattern adjacent thereto. Then, it reflects the layout of the surroundings of a pattern in which conversion difference prediction point P0 is set. As a result it is possible to predict a design data optimization amount. Therefore, as in the present embodiment, occurrence of an abrupt change in the shape of a line pattern can be suppressed in comparison with a case where the shape of the line pattern is optimized for each line pattern based on a correction rule (for example, a design rule based on the shape of a line pattern in the design data) by optimizing the design data based on the angular aperture model.

Further, in this embodiment, a line pattern can be optimized by taking mutual interference between adjacent line patterns into consideration. Therefore, the design data optimization method of this embodiment can suppress occurrence of an error (error of optimization) in which an optimized portion becomes a new error point when adjacent line patterns are respectively optimized based on a certain correction rule.

Thus, as in this embodiment, the design data optimization method to which the angular aperture model is applied can relatively easily optimization design data before determination of the process condition to data after the process condition is determined.

As described above, the design data optimization method of this embodiment may be performed to enhance the efficiency of formation and correction of design data of a semiconductor device.

(b) Method

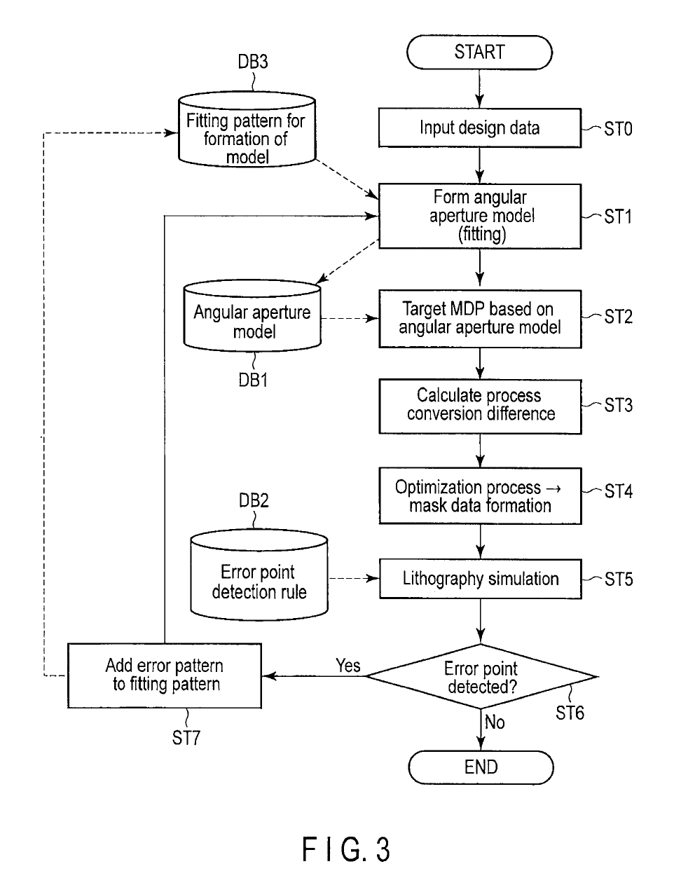

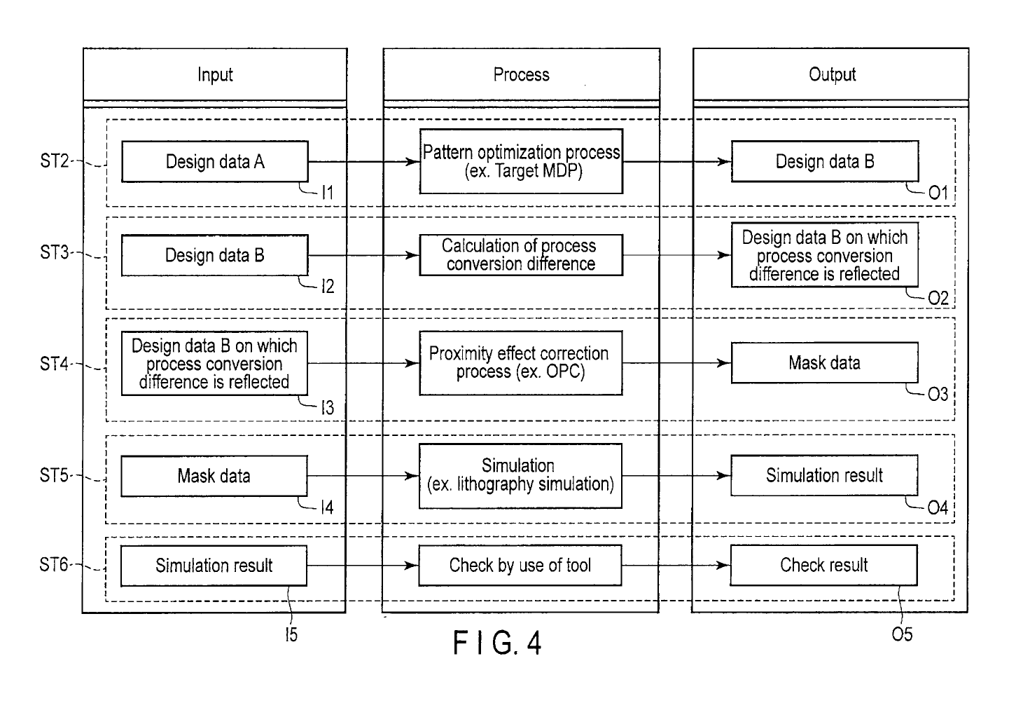

A design data optimization method and mask data formation method of this embodiment are explained with reference to FIG. 3 to FIG. 6. FIG. 3 shows a process flow of the design data optimization method and mask data formation method (photomask manufacturing method) of the present embodiment. FIG. 4 is a schematic diagram showing the correspondence relationship of data input to the computer, a process with respect to input data and data output as the result of the process. In the following description, the processing flow of the design data optimization method of this embodiment shown in FIG. 3 is explained by adequately using FIG. 1 and FIG. 2.

As shown in FIG. 3 and FIG. 4, design data 3 indicating the interconnect layout of a semiconductor device is input to the computer 1 of FIG. 1 (ST0). For example, the design data 3 is temporarily stored in the memory unit 13 of the computer 1. The control unit 11 of the computer 1 causes the processing unit 12 to perform a calculation process (optimization process) for the design data 3 based on a program 200 in which the design data optimization method and mask data formation method are described.

The control unit 11 causes the processing unit 12 to form a parameter of an angular aperture model based on fitting pattern data 21 or adjust the parameter (step ST1).

A process for forming or adjusting the parameter of the angular aperture model is called a fitting process (or simply fitting).

For example, the angular aperture model subjected to the fitting process may be an angular aperture model formed based on provisional fitting pattern data 21 before the process condition is determined or may be an angular aperture model formed based on fitting pattern data 21 after the process condition is determined.

The control unit 11 acquires fitting pattern data 21 for formation of an angular aperture model prepared based on, for example, the past experiment or manufacturing process from database DB1 of the storage device 2. The fitting process may be performed by using data stored in the storage device 2 or may be performed to newly form a parameter of an angular aperture model with respect to input design data.

For example, the width (interconnect width) of a pattern (line pattern) or the distance (space) between line patterns is increased or decreased without changing the pitch between the adjacent patterns by adjustment of a parameter for the line pattern included in the design data in the fitting process. If the process condition is determined when the fitting process is performed, for example, adjustment of the shape of a line pattern is performed to cope with the determined process condition.

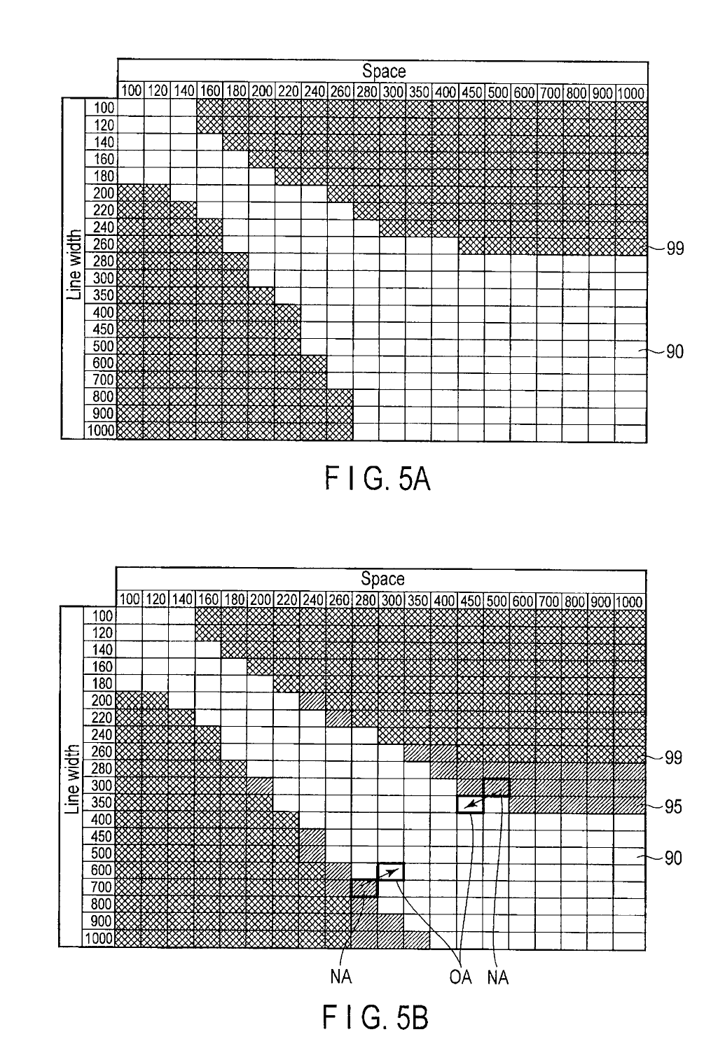

FIG. 5A and FIG. 5B each show one example of a design rule of the interconnect layout based on an angular aperture model in a certain process condition. A combination of the space and line width including an error point (error) in the angular aperture model varies depending on the process condition used in manufacturing a semiconductor device.

In FIG. 5A, a region 99 indicated by hatching indicates a combination of the space (interconnect distance) and line width (interconnect width) that form a processed shape (finished shape) including an error point before the process condition is determined. Further, a region 90 indicated by a void indicates a combination of the space and line width that can form a finished shape including no error point before the process condition is determined.

It is preferable to set a plurality of variations of fitting pattern data 21 used in the fitting process in order to enhance the precision of an angular aperture model corresponding to design data 3.

The process condition set to adjust the parameter in the fitting process may be a process condition determined to form a semiconductor device or a process condition (provisional process condition) that may be changed after the design data is optimized or mask data is formed. In the fitting process, the determined process condition may be reflected on fitting pattern data formed before the process condition is determined and fitting pattern data may be formed based on the determined process condition.

For example, a model equation of an angular aperture model formed or adjusted by the fitting process is stored as angular aperture model data 22 in angular aperture model database DB2.

The control unit 11 acquires angular aperture model data 22 corresponding to design data 3 input from a plurality of angular aperture model data items 22 stored in angular aperture model database DB2. However, angular aperture model data 22 corresponding to a portion of input design data may be acquired in some cases by means of the control unit 11. Then, the control unit 11 causes the processing unit 12 to perform the pattern optimization process for design data 3 based on the angular aperture model (step ST2).

For example, the pattern optimization process for design data 3 using angular aperture model data 22 is performed by using a design tool 18 such as Target MDP. As shown in FIG. 4, design data A (corresponding to design data of FIG. 1) as input I1 is subjected to an optimization process by taking a model equation of a dimensional conversion difference in the angular aperture model into consideration by, for example, using the design tool 18 such as Target MDP and design data B is output as output O1.

A case wherein input design data A is data formed before determination of the process condition and the process condition of a semiconductor device is adjusted or determined after the pattern optimization process is considered. In this case, an angular aperture model is formed by use of fitting pattern data after adjustment/determination of the process condition of the semiconductor device in the fitting process. In the following description, the angular aperture model formed by using fitting pattern data after adjustment/determination of the process condition of the semiconductor device may be referred to as an angular aperture model after reflection of the adjustment condition. After the angular aperture model is formed, design data B corresponding to a change of the process condition is formed by performing the optimization process again using an angular aperture model after reflection of the adjustment condition on design data A.

As shown in FIG. 5B, a combination of the space and line width in which an error point may occur (region NA indicated by oblique lines) is automatically optimized to a combination of the space and line width in which no error point occurs according to a design rule after correction by the optimization process for design data based on the angular aperture model after adjustment.

As shown in FIG. 5B, for example, a region (that is called an additional region) 95 indicating a pattern that includes a processed shape in which an error point newly occurs in the changed process condition is additionally provided in addition to the region 99 indicating a pattern (layout) that includes a processed shape that includes an error point in the provisional process condition by changing the process condition. In this case, in FIG. 5B, combination NA is the region 90 including no error point before the process condition is changed, but becomes a additional region 95 including an error point after the process condition is changed. At this time, optimization of the pattern of design data based on the angular aperture model after optimization (adjustment) is performed by reflecting fitting pattern data based on the changed process condition on the angular aperture model. As a result, the pattern of design data is automatically changed (optimized) from combination NA including an error point to combination (region) OA including no error point. For example, when the fitting process for design data is performed by use of the changed process condition, the program of the design tool 18 is automatically optimized.

The line pattern in the design data may be optimized to increase or decrease only the line width according to the layout of a pattern required for the semiconductor device or the distance between line patterns in the design data may be optimized to increase or decrease only the space.

As described above, in the design data optimization method using the angular aperture model of this embodiment, correction of design data according to a change of the process condition is significantly simplified.

If the process condition is changed in the conventional design data optimization process, the pattern of design data or the program of the design tool 18 used for optimization of combination NA including an error point to combination OA including no error point is manually optimized.

In the design data optimization method of this embodiment, the program of the design tool 18 is automatically optimized by performing a fitting process for design data in a process condition after the process condition is changed. As a result, optimization of design data can be significantly simplified according to the design data optimization method of this embodiment and a process from inputting of design data to formation of a mask can be performed in a short time.

In the process of optimizing the line pattern in design data based on the angular aperture model, optimization by taking mutual interference between adjacent line patterns with a position in the vertical direction with respect to the substrate (wafer) surface set as a reference into consideration can be performed. Therefore, in the optimization process of design data using the angular aperture model as in this embodiment, the line pattern or space in design data can be optimized with high precision in comparison with a method for correcting design data by taking only the line width and shape of a to-be-corrected (to-be-optimized) line pattern into consideration.

As shown in FIG. 3 and FIG. 4, the control unit 11 deals with design data B subjected to the pattern optimization process based on the angular aperture model as input 12 and causes the processing unit 12 to calculate and reflect the dimensional conversion difference (process conversion difference) on the design data (step ST3).

As a result, design data B obtained by reflecting the dimensional conversion difference on the pattern shape in the first design data is acquired as output O2 and thus optimization data 51 is formed. The process of reflecting the dimensional conversion difference on the design data may be referred to as a dimensional conversion difference reflection process in some cases in this embodiment. For example, the dimensional conversion difference reflection process is performed to compare design data B with an actually processed pattern and uniformly thicken or narrow the pattern shape of design data B. The dimensional conversion difference reflection process can also be performed by use of the angular aperture model.

As shown in FIG. 3 and FIG. 4, the control unit 11 causes the processing unit 12 to perform the optimization process or conversion process for design data and form mask data 52 corresponding to the design data (step ST4).

As shown in FIG. 4, design data B on which optimization based on the angular aperture model and a dimensional conversion difference are reflected is dealt with as input 13 and design data B is subjected to an optical proximity effect optimization process (OPC), for example. As a result, mask data 52 used for manufacturing a photomask as output O3 is formed. A line pattern (interconnect pattern) included in mask data is called a line mask pattern (interconnect mask pattern).

As shown in FIG. 3 and FIG. 4, the control unit 11 performs a simulation for the formed mask data by use of, for example, a simulator 4 (step ST5). By the simulation process, it is checked (verified) whether or not an error point (process error portion, hot spot) occurs in a line mask pattern of the formed mask data and between adjacent line mask patterns.

Therefore, as shown in FIG. 4, a simulation is performed for mask data as input 14. The simulation process performed is a lithography simulation, for example. As a result, the simulation result of mask data as output O4 is acquired.

The control unit 11 reads error point detection rule data 23 from database DB3 stored in the storage device 2. The control unit 11 confirms the presence or absence of an error point in line mask pattern and between adjacent line mask patterns by use of, for example, the design tool 18 based on the simulation result for mask data and error point detection rule data 23 (step ST6).

The quality of formed mask data is enhanced by performing the mask data (or design data) verification process by use of the above simulation in addition to the optimization process for design data based on the angular aperture model.

When an error point is detected in mask data verified by simulation, the fitting process is performed again. At this time, a line pattern including an error point in mask data or a combination of the line pattern and a space pattern is reflected on a fitting pattern to adequately correct a line pattern in which the error point is detected in the mask data or a combination of the line pattern and the space pattern (step ST7).

Fitting pattern data 21 in which a line pattern including an error point in mask data or a combination of the line pattern and a space pattern is added is formed and data 21 formed during the design data optimization process and mask data formation process is newly stored in database DB1 of the fitting pattern 21.

Then, the fitting process (step ST1) of the angular aperture model is performed again for design data that may include an error point and a process from step ST2 to step ST5 is repeatedly performed until an error point is not detected in formed mask data.

If no error point is detected, the design data optimization process and mask data formation process based on the angular aperture model are terminated.

A photomask is formed based on formed mask data and a semiconductor device is formed by use of the formed photomask.

Thus, an angular aperture model used for correcting input design data is formed and the input design data is optimized based on the angular aperture model.

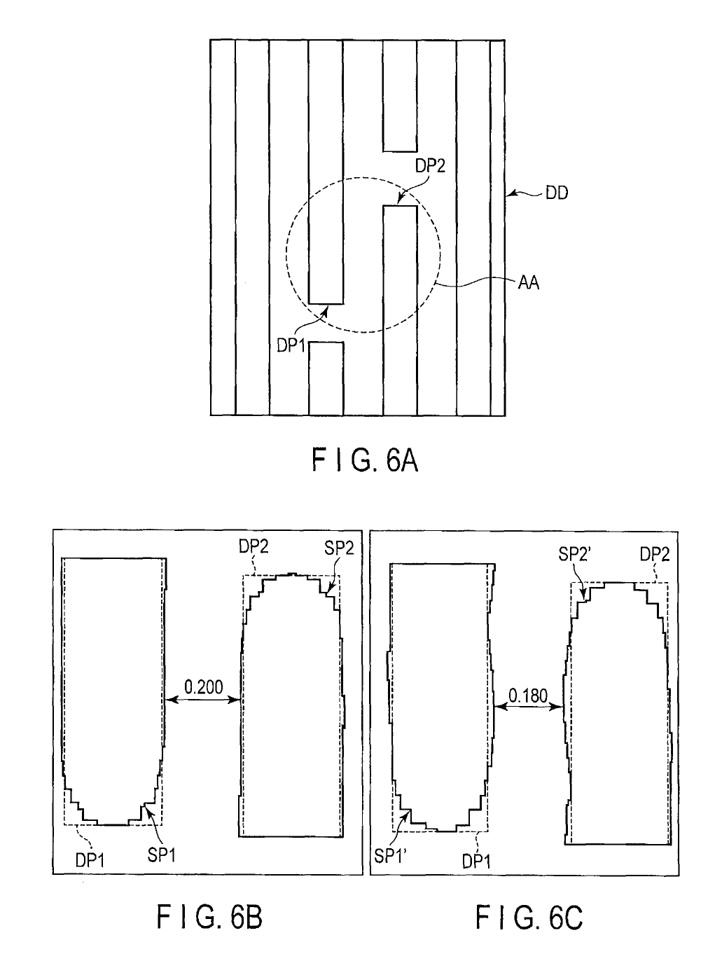

A pattern shape formed by use of the design data optimization method of this embodiment is explained with reference to FIG. 6A, FIG. 68 and FIG. 6C.

FIG. 6A shows the layout of a line pattern in design data DD supplied as input. FIG. 6B shows simulation shapes SP1, SP2 obtained when adjacent line patterns DP1, DP2 in area AA of design data DD are optimized by performing the design data optimization process based on an angular aperture model. FIG. 6C shows simulation shapes SP1′, SP2′ obtained when adjacent line patterns DP1, DP2 in area AA of design data DD are optimized by performing a known method. In FIG. 6B and FIG. 6C, the shapes indicated by broken lines correspond to line patterns DP1, DP2 of design data DD.

In FIG. 6B and FIG. 6C, line patterns DP1, DP2 in design data DD of FIG. 6A are subjected to an optimization process based on an angular aperture model and an optimization process by a known method.

As shown in FIG. 6B, simulation patterns SP1, SP2 to be formed have line widths approximately equal to those of design patterns DP1, DP2 when a design data optimization process based on the angular aperture model described in this embodiment is performed. The space between adjacent patterns SP1 and SP2 is set to 0.200 (given value).

As shown in FIG. 6C, when adjacent line patterns DP1, DP2 in design data DD are optimized by use of a known technique, the line widths of simulation patterns SP1′, SP2′ become larger in comparison with a case of a optimization process based on the angular aperture model. As a result, the distance between adjacent simulation patterns SP1′ and SP2′ is set to 0.180 (given value) and becomes smaller than the space between adjacent simulation patterns SP1 and SP2 based on the angular aperture model of FIG. 6B.

Thus, the optimization process for line patterns of design data based on the angular aperture model can suppress the distance between adjacent line patterns from being reduced due to pattern correction.

As described above, the design data optimization method of this embodiment corrects design data by performing an optimization process for the line pattern and the space between the line patterns by using the angular aperture model.

In the optimization process of the line pattern in design data based on a known rule base, an unexpected optimization process may be performed for a certain line pattern in addition to a to-be-corrected line pattern in some cases. Further, if both of adjacent line patterns are subjected to an optimization process, an optimization portion may become an error point. In the optimization process for known design data, a pattern transferred onto the wafer by exposure may be short-circuited or disconnected due to an error point occurring by correction and the above unexpected optimization process. If a rule used for optimization or design data is changed to suppress occurrence of an error point of a line pattern (or space) caused by the optimization process for the design data, an error point may occur in a new portion and correction of design data and occurrence of an error point (error of optimization) become continuous. As a result, the optimization process for design data becomes complicated and the TAT of a semiconductor device becomes long.

On the other hand, the design data optimization method of this embodiment performs a design data optimization process by use of the angular aperture model in which a reference point of the dimensional conversion difference (process conversion difference) is set in the vertical direction with respect to the wafer surface by taking mutual interference between a to-be-corrected line pattern and a line pattern adjacent thereto into consideration. Therefore, the design data optimization method of this embodiment can relatively simply optimize the line pattern and space pattern in design data. As a result, the design data optimization process can be avoided from becoming complicated and the TAT of a semiconductor device can be reduced. Further, design data can be optimized with high precision and the manufacturing yield of semiconductor devices can be enhanced by use of the angular aperture model for correction of the design data.

Additionally, a photomask of high quality can be formed by forming mask data used for manufacturing a photomask based on design data optimized by use of the design data optimization method of this embodiment and the manufacturing yield of semiconductor devices can be enhanced.

As described above, the design data optimization method of this embodiment and the method for forming the mask data based on the optimized design data can be provided as the program 200 stored in the storage medium 19.

As described above, according to the design data optimization method of this embodiment, the efficiency of formation and correction of design data of a semiconductor device can be enhanced.

[Others]

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A design data optimization method comprising:
forming an angular aperture model, in first design data including a first and a second line patterns indicating an interconnect layout of a semiconductor device, based on an angular aperture between the first line pattern in which a conversion difference prediction point is set in a vertical direction with respect to a wafer surface and the second line pattern adjacent the first line pattern; and
changing at least one of a distance between the first and second line patterns and a line width of the first and second line patterns included in the first design data based on the angular aperture model and optimizing the first design data to second design data including the first and second line patterns changed.

2. The design data optimization method according to claim 1, further comprising:
forming mask data used for manufacturing a photomask based on the second design data and verifying whether a mask pattern in the mask data includes an error point at the time of formation of the semiconductor device.

3. The design data optimization method according to claim 2, further comprising:
reflecting at least one of a distance between line patterns and line width of a line pattern corresponding to the error point on the angular aperture when the mask pattern includes the error point.

4. The design data optimization method according to claim 1, further comprising:
calculating a dimensional conversion difference between the line width of the first and second line patterns and an interconnect width of an interconnection corresponding to the first and second line patterns formed on the wafer based on the angular aperture model and reflecting the dimensional conversion difference on the second design data.

5. The design data optimization method according to claim 1, wherein when a process condition of the semiconductor device is changed, the angular aperture model is optimized by use of a fitting pattern data corresponding to a change of the process condition.

6. The design data optimization method according to claim 1, wherein the angular aperture is calculated by use of a first dimension from an upper portion of a first interconnection corresponding to the first pattern to a position of a conversion difference prediction point in the vertical direction with respect to the wafer surface and a second dimension of a space between the first interconnection corresponding to the first line pattern and a second interconnection corresponding to the second line pattern in a horizontal direction with respect to the wafer surface.

7. The design data optimization method according to claim 1, wherein the angular aperture model is formed by use of a first database including line widths of the first and second line patterns, a distance between the first and second line patterns and suitability of a combination of the line width and the distance.

8. A non-transitory computer-readable storage medium having a computer program stored in the medium comprising:
forming an angular aperture model, in a first design data including a first and a second line patterns indicating an interconnect layout of a semiconductor device by a computer, based on an angular aperture between the first line pattern in which a conversion difference prediction point is set in a vertical direction with respect to a wafer surface and the second line pattern adjacent the first line pattern; and
changing at least one of a distance between the first and second line patterns and a line width of the first and second line patterns included in the first design data based on the angular aperture model and correcting the first design data to second design data including the first and second line patterns changed by the computer.

9. The non-transitory computer-readable storage medium having a computer program stored in the medium according to claim 8, further comprising:
forming mask data used for manufacturing a photomask based on the second design data and verifying whether a mask pattern in the mask data includes an error point at the time of formation of the semiconductor device by the computer.

10. The non-transitory computer-readable storage medium having a computer program stored in the medium according to claim 9, further comprising:
reflecting at least one of a distance between line patterns and line width of line pattern corresponding to the error point on the angular aperture model by the computer when the mask pattern includes the dangerous point.

11. The non-transitory computer-readable storage medium having a computer program stored in the medium according to claim 8, wherein when a process condition of the semiconductor device is changed, the angular aperture model is optimized by use of a fitting pattern data corresponding to a change of the process condition, by the computer.

12. The non-transitory computer-readable storage medium having a computer program stored in the medium according to claim 8, wherein the angular aperture is calculated, by the computer, by use of a first dimension from an upper portion of a first interconnection corresponding to the first pattern to a position of a conversion difference prediction point in the vertical direction with respect to the wafer surface and a second dimension of a space between the first interconnection corresponding to the first line pattern and a second interconnection corresponding to a second line pattern in a horizontal direction with respect to the wafer surface.

13. A photomask manufacturing method comprising:
forming an angular aperture model, in a first design data including a first and a second line patterns indicating an interconnect layout of a semiconductor device, based on an angular aperture between the first line pattern in which a conversion difference prediction point is set in a vertical direction with respect to a wafer surface and the second line pattern adjacent the first line pattern;
changing at least one of a distance between the first and second line patterns and line width of the first and second line patterns included in the first design data based on the angular aperture model and correcting the first design data to second design data including the first and second line patterns changed, and
forming mask data corresponding to the semiconductor device based on the second design data.

14. The photomask manufacturing method according to claim 13, further comprising:
verifying whether a mask pattern in the mask data includes an error point at the time of formation of the semiconductor device.

15. The photomask manufacturing method according to claim 14, further comprising:
reflecting at least one of a distance between line patterns and line width of line pattern corresponding to the error point on the angular aperture model when the mask pattern includes the dangerous point.

16. The photomask manufacturing method according to claim 13, wherein when a process condition of the semiconductor device is changed, the angular aperture model is optimized by use of a fitting pattern data corresponding to a change of the process condition.

17. The photomask manufacturing method according to claim 13, wherein the angular aperture is calculated by use of a first dimension from an upper portion of a first interconnection corresponding to the first pattern to a position of a conversion difference prediction point in the vertical direction with respect to the wafer surface and a second dimension of a space between the first interconnection corresponding to the first line pattern in a horizontal direction with respect to the wafer surface and a second interconnection corresponding to a second line pattern.
